(19) United States
(12) Patent Application Publication
(10) Pub. No.: US 2009/0276247 A1
(43) Pub. Date: Nov. 5, 2009

(54) SYSTEMS AND METHODS FOR WEB-BASED GROUP INSURANCE/BENEFITS PROCUREMENT AND/OR ADMINISTRATION

(76) Inventor: Roger Glenn Howell, Shaverton, PA (US)

Correspondence Address: SUTHERLAND ASBILL & BRENNAN LLP, 999 PEACHTREE STREET, N.E., ATLANTA, GA, 30309, US

(21) Appl. No.: 12/401,165

(22) Filed: Mar. 10, 2009

Related U.S. Application Data
(60) Provisional application No. 61/035,182, filed on Mar. 10, 2008.

(51) Int. Cl. G06Q 40/00

(52) U.S. Cl. 705/4

(57) ABSTRACT

Systems and methods may include receiving a request for quote information from a customer computer via a website; responsive to the request, providing rates for a plurality of insurance/benefits products associated with one or more carriers via the website, where the plurality of insurance/benefits products includes an insurance/benefits product associated with a carrier of the one or more carriers; receiving, from the customer computer via the website, a purchase instruction requesting a purchase of at least the insurance/benefits product; receiving, from the customer computer via the website, an electronic application, where the electronic application is executed electronically; and directing a transmission of the electronic application to the carrier of the insurance/benefits product for approval or denial, where upon receiving an approval response or a denial response from the carrier, notifying a customer of the approval response or the denial response for the insurance/benefits product.

### RELATED APPLICATION

This application claims priority to U.S. Provisional Application No. 61/035,182, filed Mar. 10, 2008, and entitled “SYSTEMS AND METHODS FOR WEB-BASED GROUP INSURANCE/BENEFITS PROCUREMENT AND/OR ADMINISTRATION,” which is hereby incorporated by reference in its entirety.

### FIELD OF THE INVENTION

The invention relates generally to insurance/benefits procurement and/or administration, and more particularly to, systems and methods for web-based group insurance/benefits procurement and/or administration.

### SUMMARY OF THE INVENTION

According to an example embodiment of the invention, there is a system. The system includes a memory for storing computer-executable instructions, and a processor in communication with the memory. The processor is operable to execute the computer-executable instructions to receive a request for quote information from a customer computer via a website; responsive to the request, provide rates for a plurality of insurance/benefits products associated with one or more carriers via the website, where the plurality of insurance/benefits products includes a first insurance/benefits product associated with a first carrier of the one or more carriers; receive, from the customer computer via the website, a purchase instruction requesting a purchase of at least the first insurance/benefits product; receive, from the customer computer via the website, a first electronic application, where the first electronic application is executed electronically; and direct a transmission of the first electronic application to the first carrier of the first insurance/benefits product for approval or denial, where upon receiving an approval response or a denial response from the first carrier, notifying a customer of the approval response or the denial response for the first insurance/benefits product.

### BRIEF DESCRIPTION OF THE DRAWINGS

Reference will now be made to the accompanying drawings, which are not necessarily drawn to scale, and wherein:

FIG. 1 illustrates an example system for web-based group insurance/benefits procurement and/or administration, according to an example embodiment of the invention.

FIG. 2A illustrates an example overview flow diagram for procurement and/or administration of one or more insurance/benefits products or plans, according to an example embodiment of the invention.

FIG. 2B illustrates an example flow diagram for obtaining quotes for one or more insurance/benefits products or plans, according to an example embodiment of the invention.

FIG. 2C illustrates an example flow diagram for purchasing one or more insurance/benefits products or plans, according to an example embodiment of the invention.

FIG. 2D illustrates an example flow diagram for enrolling one or more employees and dependents for the one or more insurance/benefits products or plans, according to an example embodiment of the invention.

FIGS. 3A-3K illustrates example web pages that may support a web-based insurance procurement and/or administration system, according to an example embodiment of the invention.

### DETAILED DESCRIPTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those of ordinary skill in the art. Like numbers refer to like elements throughout.

Example embodiments of the invention may provide for web-based systems and methods by which customer/employers can procure or administer one or more insurance/benefits plans or products, including group insurance/benefits plans or products. Examples of insurance/benefits plans or products may include, but are not limited to health insurance, dental & vision insurance, life & disability insurance, and flexible spending accounts, and other wellness and occupational health products. According to an example embodiment of the invention, these insurance/benefits plans or products may be offered by a variety of carriers through example embodiments of the system described herein.

System Overview

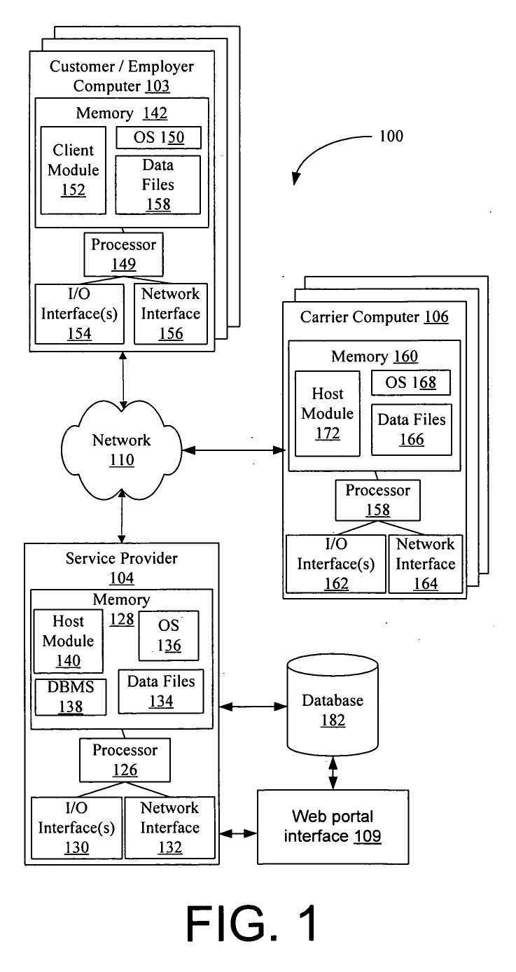

FIG. 1 illustrates an example system 100 for web-based group insurance/benefits procurement and/or administration, according to an example embodiment of the invention.

As shown in FIG. 1, the system 100 may include a customer/employer computer 103, a service provider 104, and a carrier computer 106, which are each configured for accessing and reading associated computer-readable media having stored thereon data and/or computer-executable instructions for implementing the various methods of the invention. Generally, network devices and systems, including the one or more customer/employer computers 103, service providers 104, and carrier computers 106 have hardware and/or software for transmitting and receiving data and/or computer-executable instructions over a communications link and a memory for storing data and/or computer-executable instructions. These network devices and systems may also include a processor for processing data and executing computer-executable instructions, as well as other internal and peripheral components that are well known in the art. As used herein, the term “computer-readable medium” may describe any form of memory or a propagated signal transmission medium. Propagated signals representing data and computer program instructions may be transferred between network devices and systems.

As shown in FIG. 1, the customer/employer computer 103, service provider 104, and carrier computer 106 may be in communication with each other via a network such as network 110, which as described below can include the Internet or one or more separate or shared private and public networks. Each of these components—the customer/employer computer 103, the service provider 104, the carrier computer 106, and the network 110—will now be discussed in further detail.

First, the customer/employer computer 103 may be any processor-driven device, such as a personal computer, laptop computer, handheld computer, and the like. In addition to having a processor 149, the customer/employer computer 103 may further include a memory 142, input/output (“I/O”) interface(s) 154, and a network interface 156. The memory 142 may store data files 158 and various program modules, such as an operating system (“OS”) 150 and a client module 152. The memory 142 may be any computer-readable medium, coupled to the processor 149, such as RAM, ROM, and/or a removable storage device for storing data files 158 and a database management system (“DBMS”) to facilitate management of data files 158 and other data stored in the memory 142 and/or stored in separate databases. The OS 150 may be, but is not limited to, Microsoft Windows®, Apple OSX™, Unix, or a mainframe operating system. The client module 152 may be an Internet browser or other software, including a dedicated program, for interacting with the service provider 104. For example, a customer/employer may utilize the client module 152 to interact with the service provider 104 via website to procure or otherwise administer group insurance/benefits as described herein. The client module 152 may also be utilized to retrieve or otherwise receive data, messages, or responses from the service provider 104.

Still referring to the customer/employer computer 103, the I/O interface(s) 154 may facilitate communication between the processor 149 and various I/O devices, such as a keyboard, mouse, printer, microphone, speaker, monitor, bar code readers/scanners, RFID readers, and the like. The network interface 156 may take any of a number of forms, such as a network interface card, a modem, a wireless network card, and the like. It will be appreciated that while customer/employer computer 103 has been illustrated as a single computer or processor, the customer/employer computer 103 may be comprised of a group of computers or processors, according to an example embodiment of the invention.

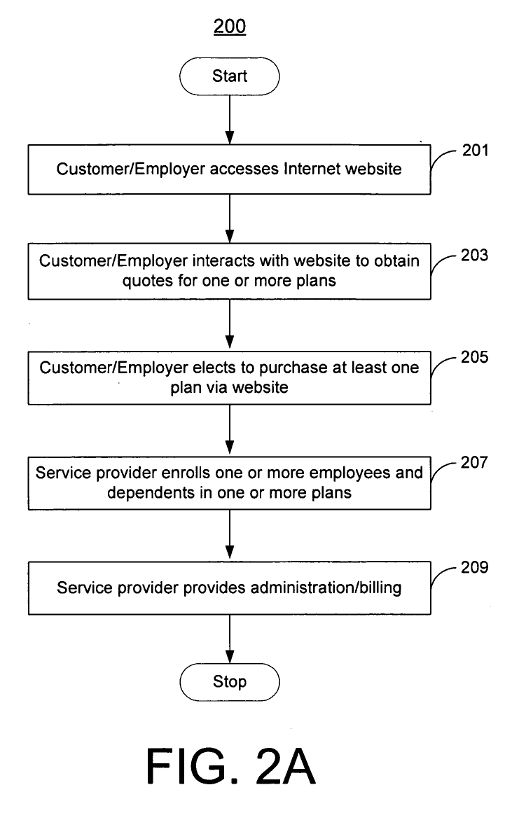

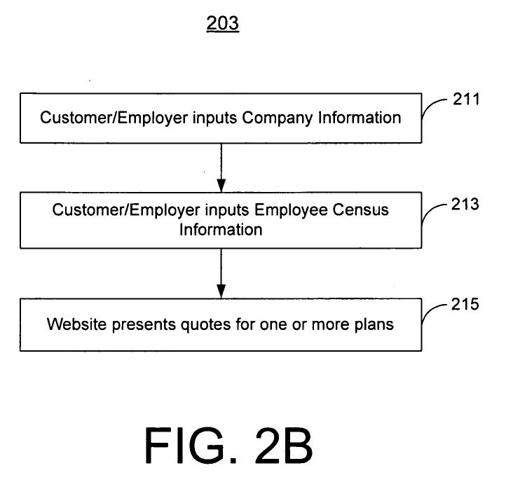

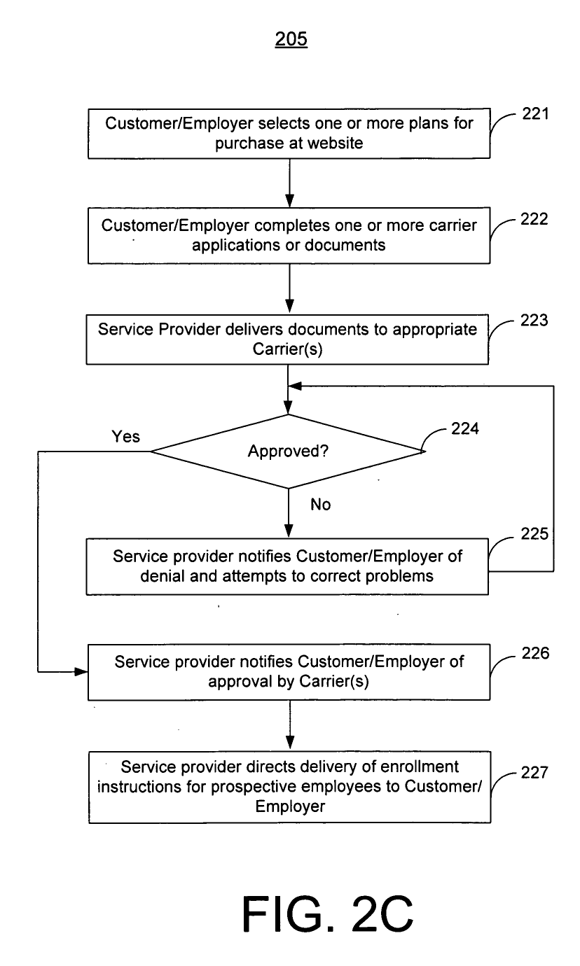

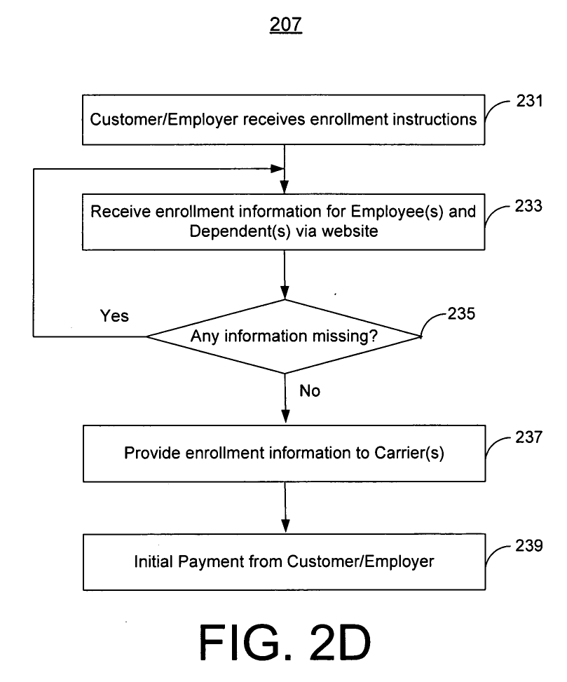

The service provider 104 may be any processor-driven device that is configured for receiving, processing, and fulfilling requests from the customer/employer computer 103 and/or carrier computer 106. The service provider 104 may include a processor 126, a memory 128, input/output (“I/O”) interface(s) 130, and a network interface 132. The memory 128 may be any computer-readable medium, coupled to the processor 126, such as RAM, ROM, and/or a removable storage device for storing data files 134 and a database management system (“DBMS”) 138 to facilitate management of data files 134 and other data stored in the memory 128 and/or stored in one or more databases 144. The memory 128 may store data files 134 and various program modules, such as an operating system (“OS”) 136, a database management system (“DBMS”) 138, and the host module 140. The OS 136 may be, but is not limited to, Microsoft Windows®, Apple OSX™, Unix, or a mainframe operating system. The host module 140 may receive, process, and respond to requests from the client module 152 of the customer/employer computer 103 and/or from the host module 172 of the carrier computer 106. The service provider 104 may include additional program modules or applications for performing other pre-processing or post-processing methods described herein, including supporting or providing one or more of the blocks illustrated in FIGS. 2A-2D.

In addition, a web portal interface 109 may also be operative with or otherwise included with the service provider 104. In particular, the web portal interface 109 may allow for a customer/employer computer 103 or another computer to access the service provider 104 via a website. For example, a customer/employer computer 103 may access the web portal interface 109 via the Internet of network 110. The web portal interface 109 may be provided by a separate processor-based system that is distinct from the service provider 104. By way of example, the web portal interface 109 may be provided by a web server that is in communication with network 110 and the service provider 104. Alternatively, it will be appreciated that the web portal interface 109 may also be incorporated into the service provider 104 as well, perhaps as part of host module 140, according to another example embodiment of the invention.

The service provider 104 and/or web portal interface 109 may also include or be in communication with one or more database(s) 182, according to an example embodiment of the invention. The database 182 may store, for example, access information (e.g., username, password, etc.), insurance/benefits plan comparisons, summary plan descriptions, table rates and other pricing information, carrier information, application documents, payment information/instructions, and the like. The database 182 may also store quote information, such as company information or employee information (e.g., employee census information), received from a customer/employer computer 103. The database 182 may also store benefits and billing information. It will be appreciated that yet other information received or provided to customers/employers and carriers may be stored in database 182, according to an example embodiment of the invention. Although a single database 182 is referred to herein for simplicity, those skilled in the art will appreciate that multiple physical and/or logical databases may be used to store the above mentioned data. For security and performance purposes, the service provider 104 may have a dedicated connection to the database 182. However, the service provider 104 may also communicate with the database 182 via a network 110, as shown. In other embodiments of the invention, the service provider 104 may include the database 182 locally. The service provider 104 may also otherwise be part of a distributed or redundant DBMS.

The carrier computer 106 may be any processor-driven device, such as, but not limited to, a server computer, a mainframe computer, one or more networked computers, a desktop computer, a personal computer, a laptop computer, a mobile computer, a handheld portable computer, a digital assistant, a personal digital assistant, a digital tablet, an Internet appliance, or any other processor-based device. The carrier computer 106 may include a processor 158, a memory 160, input/output (“I/O”) interface(s) 162, and a network interface 164. The memory 160 may be any computer-readable medium, coupled to the processor 158, such as RAM, ROM, and/or a removable storage device for storing data files 166 and a database management system (“DBMS”) to facilitate management of data files 166 and other data stored in the memory 160 and/or stored in separate databases. The memory 160 may store data files 166 and various program modules, such as an operating system (“OS”) 168, a database management system (“DBMS”), and a host module 172. The OS 168 may be, but is not limited to, Microsoft Windows®, Apple OSX™, Unix, or a mainframe operating system. The host module 172 may receive, process, and respond to requests from the host module 140 of the service provider 104. In an example embodiment of the invention, a carrier may utilize host module 172 of carrier computer 106 to communicate electronically with the service provider 104 using network 110.

Still referring to the carrier computer 106, the I/O interface(s) 162 may facilitate communication between the processor 158 and various I/O devices, such as a keyboard, mouse, printer, microphone, speaker, monitor, bar code readers/scanners, RFID readers, and the like. The network interface 164 may take any of a number of forms, such as a network interface card, a modem, a wireless network card, and the like. It will be appreciated that while the carrier computer 106 has been illustrated as a single computer or processor, the carrier computer 106 may be comprised of a group of computers or processors, according to an example embodiment of the invention.

It will be appreciated that some carriers may not necessarily utilize a carrier computer 106 to communicate with a service provider 104 via network 110. For example, some carriers may utilize other communication means, including facsimile or personal correspondence/postal mail to communicate with the service provider 104 as part of a procurement/administration process, as described herein. Many variations in electronic and non-electronic communication types are available without departing from example embodiments of the invention.

The network 110 may include any telecommunication and/or data network, whether public, private, or a combination thereof, including a local area network, a wide area network, an intranet, an internet, the Internet, intermediate hand-held data transfer devices, a publicly switched telephone network (PSTN), and/or any combination thereof and may be wired and/or wireless.

Generally, each of the memories and data storage devices, such as the memories 142, 128, 160 and the database 182, and/or any other memory and data storage device, can store data and information for subsequent retrieval. In this manner, the system 100 can store various received or collected information in memory or a database associated with one or more customer/employer computers 103, service providers 104, and/or carrier computers 106. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices. In one example embodiment, for security, the service provider 104 (or any other entity) may have a dedicated connection to the database 182, as shown; though, in other embodiments, the service provider 104 or another entity may communicate with the database 182 via a network such as network 110.

Suitable processors, such as the processors 149, 126, 158 of the customer/employer computers 103, service providers 104, and/or carrier computers 106, respectively, may comprise a microprocessor, an ASIC, and/or a state machine. Example processors can be those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript. Furthermore, any of the processors may operate any operating system capable of supporting locally executed applications, client-server based applications, and/or browser or browser-enabled applications.

The system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. For example, in one example embodiment, the service provider 104 (or the customer/employer computer 103/carrier computer 106) may be implemented as a specialized processing machine that includes hardware and/or software for performing the methods described herein. Accordingly, embodiments of the invention should not be construed as being limited to any particular operating environment, system architecture, or device configuration.

System Operation

Embodiments of the example system 100 of FIG. 1 may be utilized in providing a web-based group insurance/benefits procurement and administration solution for customers/employers. In an example embodiment of the invention, the system 100 may be utilized by small and midsize customers/employers, which may include perhaps 2-99 employees. The system 100 may allow customers/employers to access group health, dental, vision, life, disability and flexible benefit administration, as well as yet other insurance/benefits administration, including those associated with wellness and/or occupational health products via an Internet website.

FIG. 2A illustrates a high-level overview of a flow diagram 200 for web-based group insurance/benefits procurement and administration, according to an example embodiment of the invention. FIG. 2A may will be described in accordance with the following blocks: (i) website access, (ii) quotes, (iii) purchasing, (iv) enrollment, and (v) administration.

i. Website Access

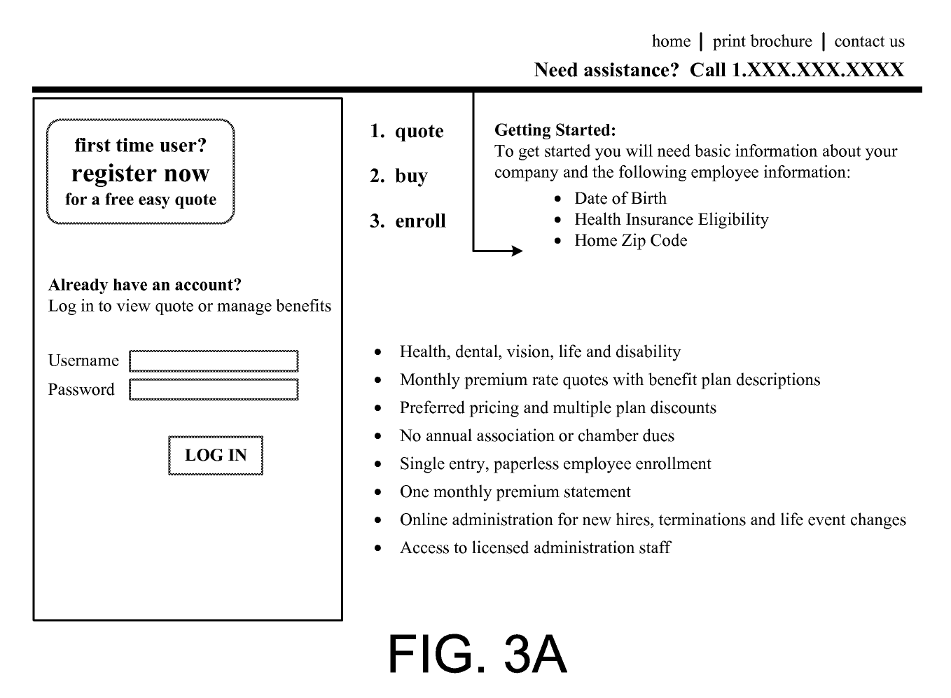

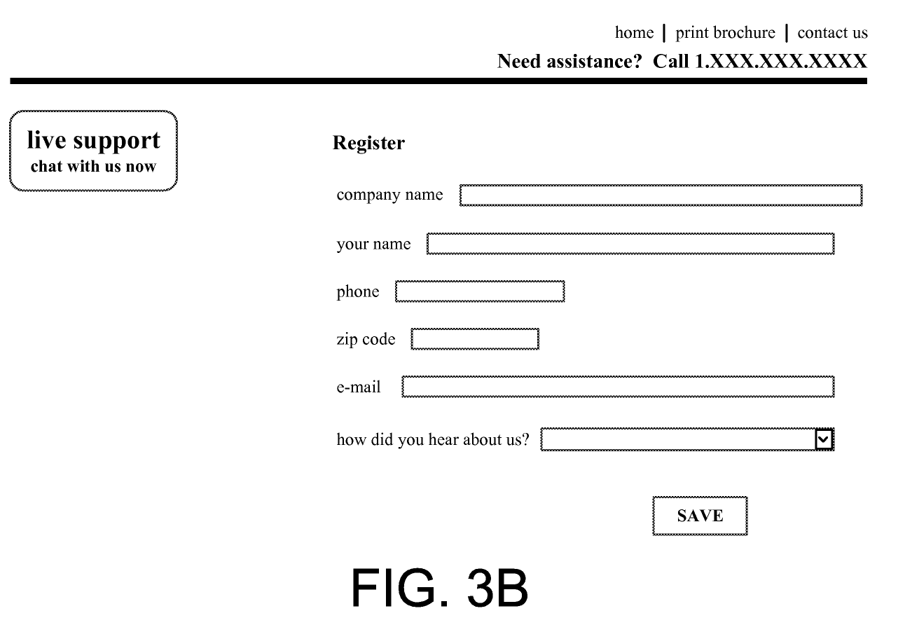

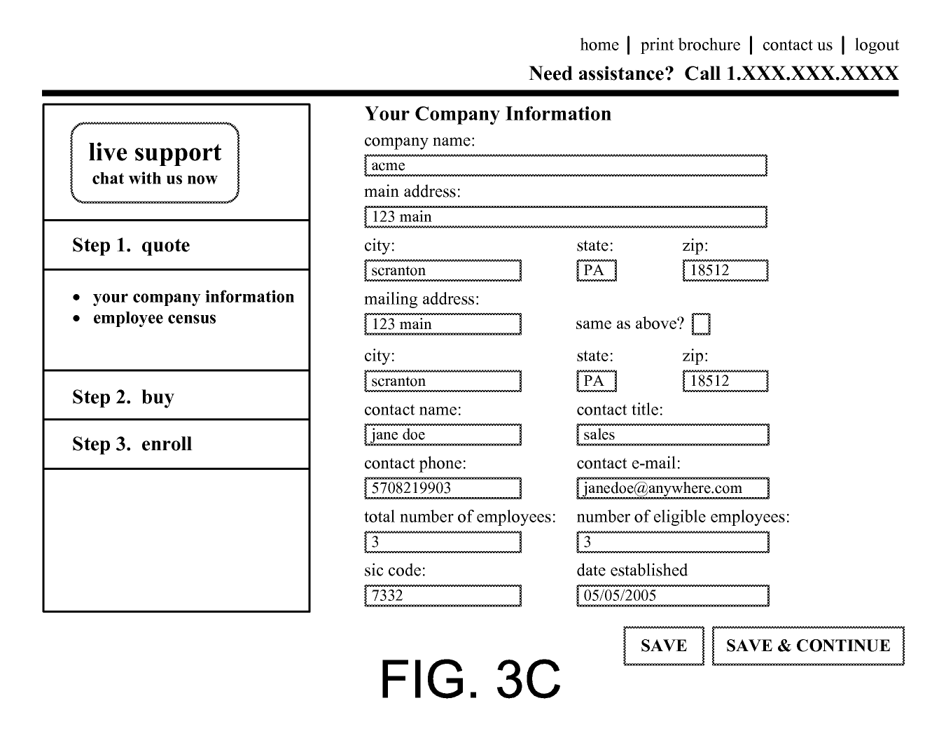

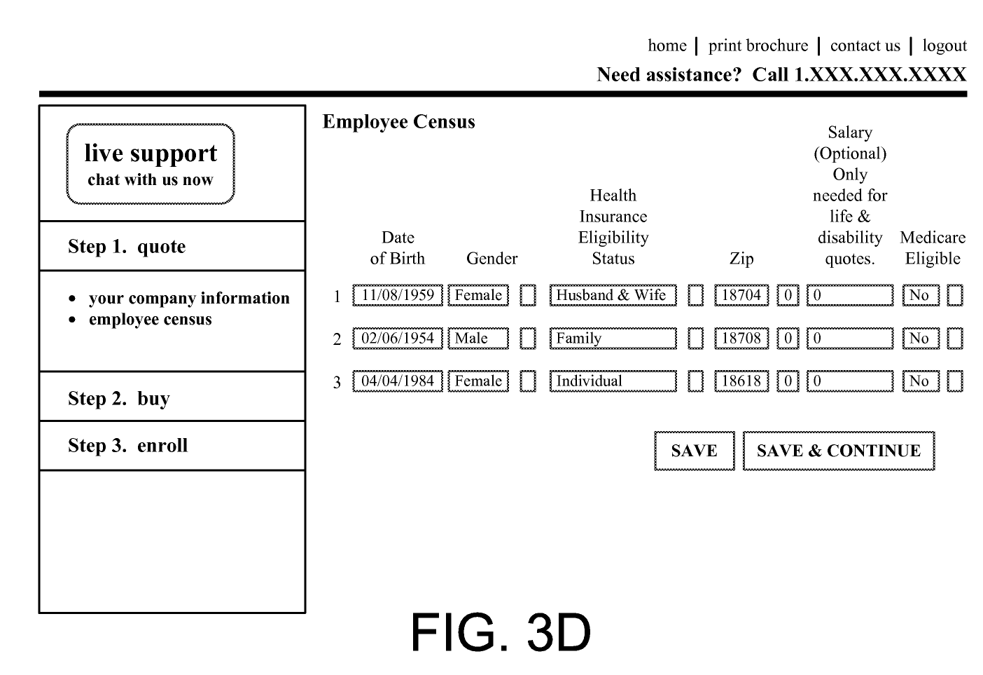

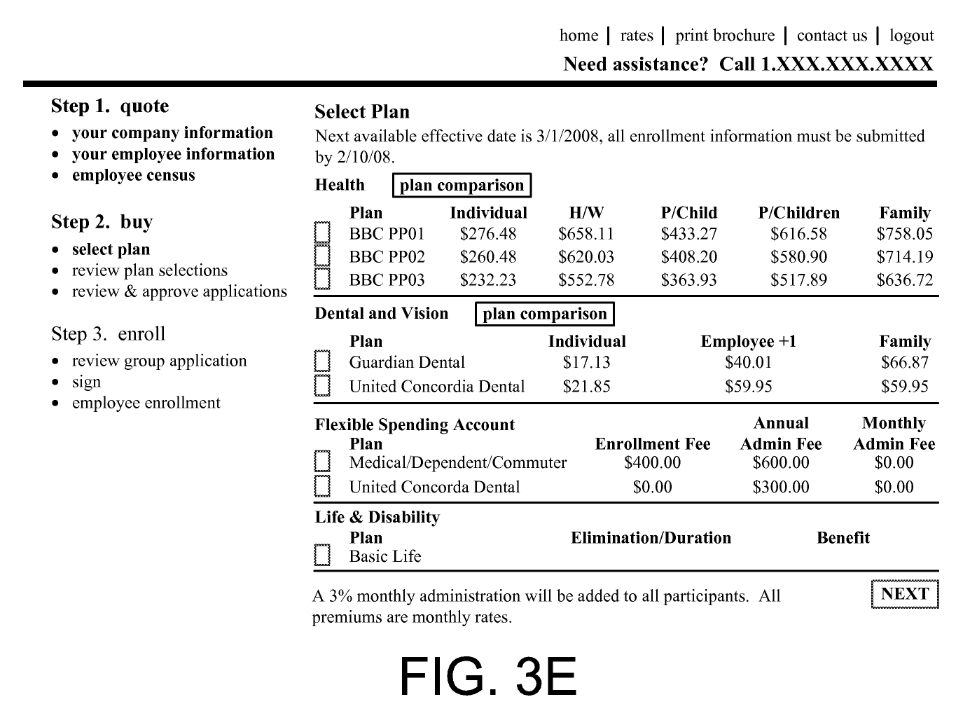

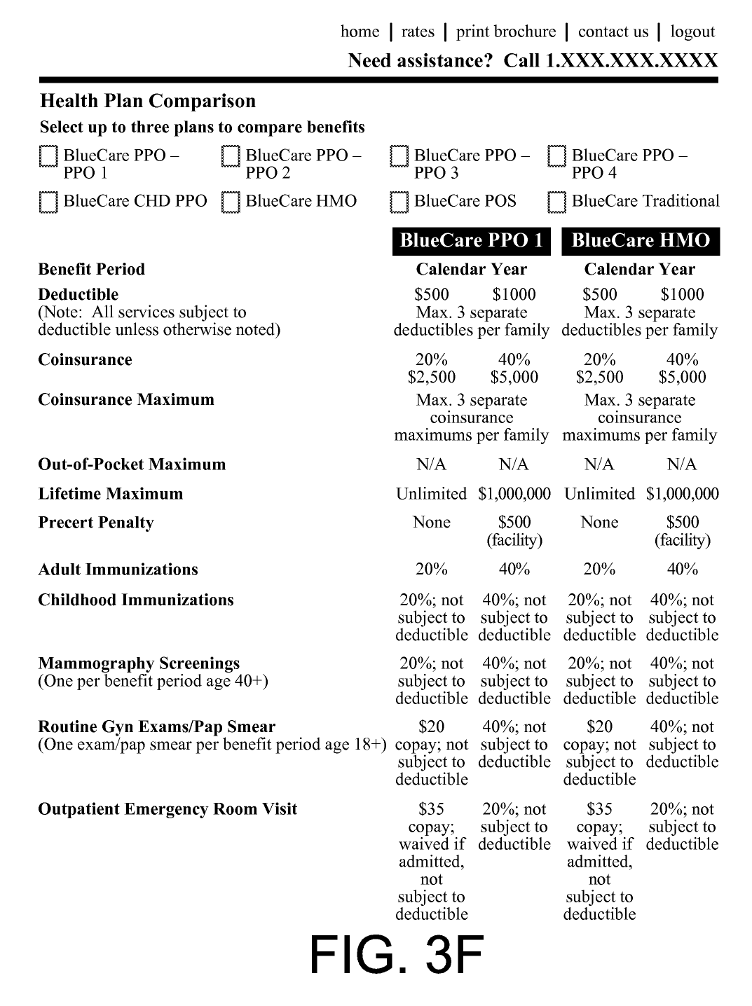

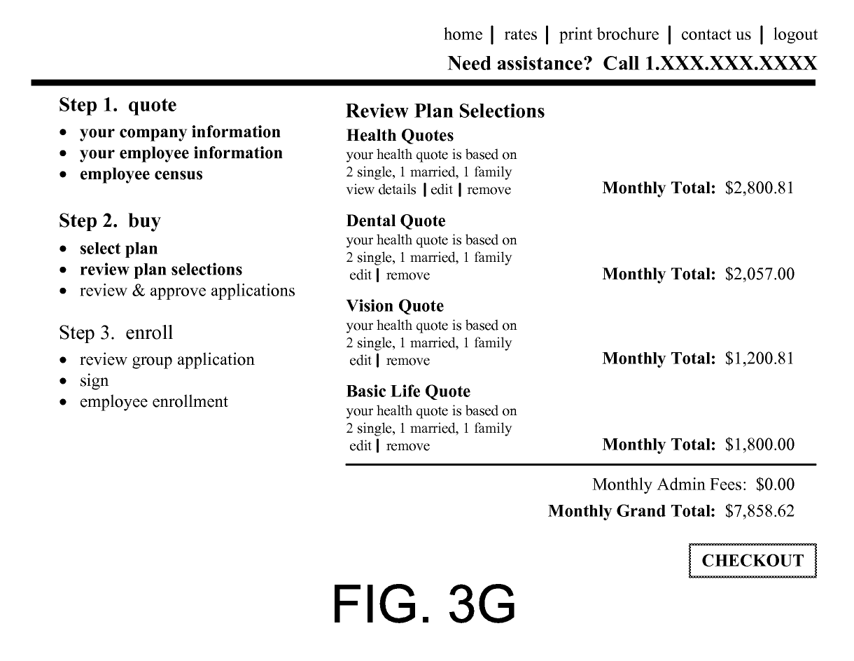

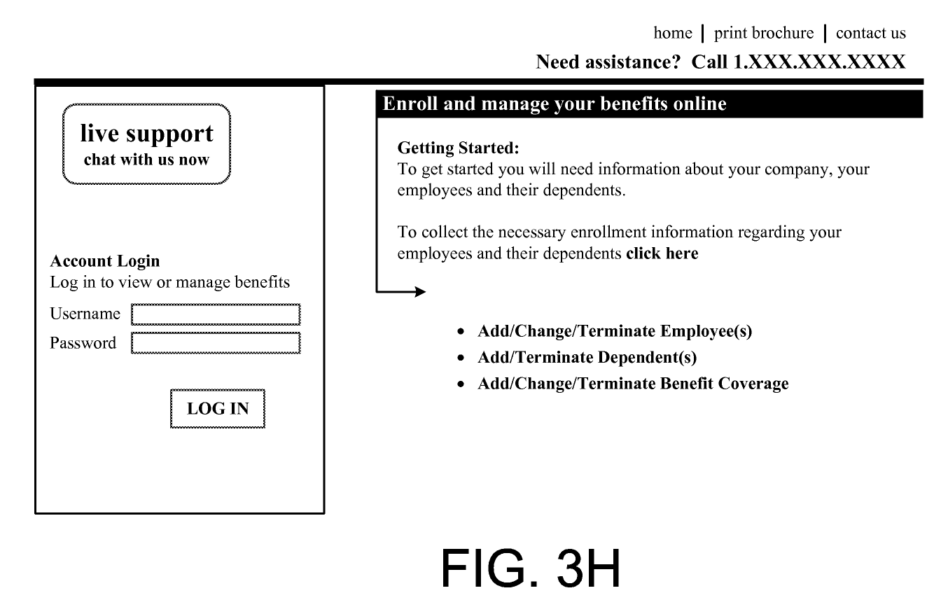

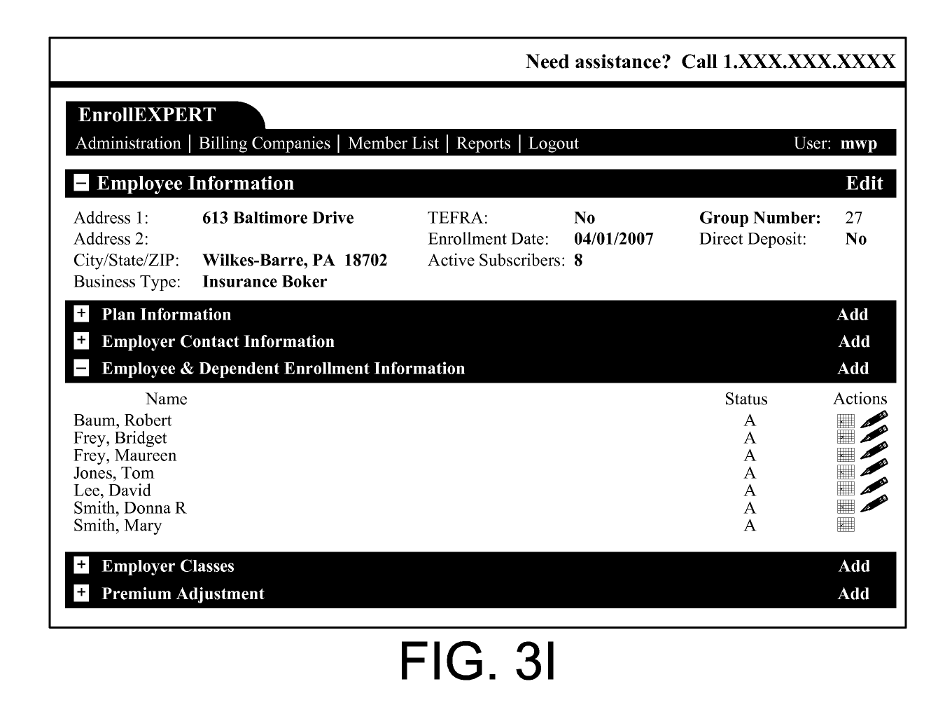

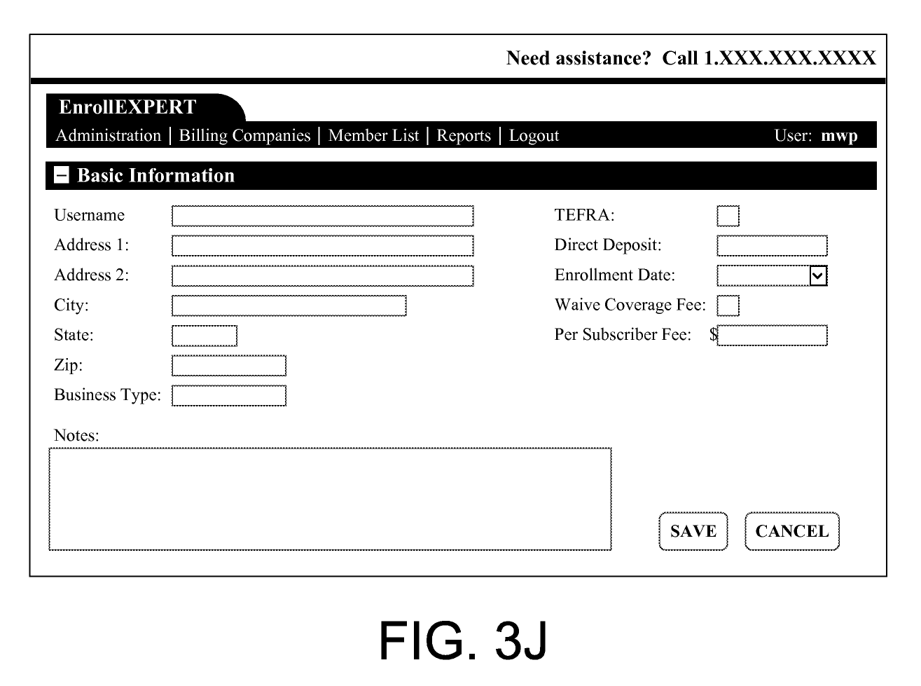

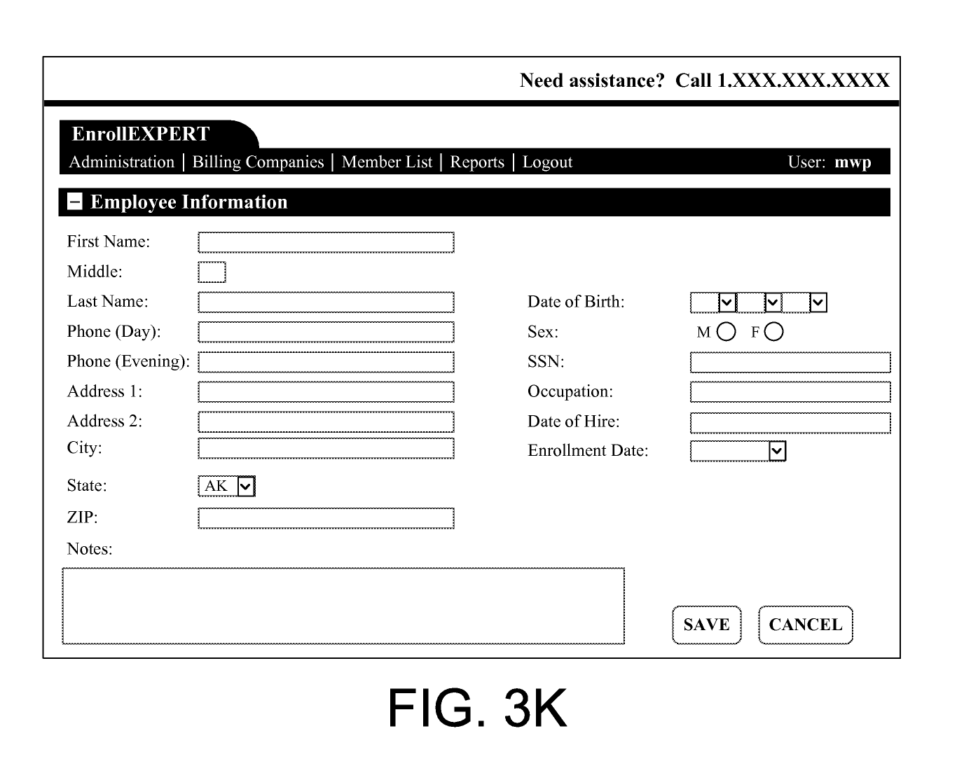

In block 201 of FIG. 2A, a customer/employer may utilize a customer/employer computer 103 to access an Internet website for group insurance/benefits procurement and administration. For example, the customer/employer may access the website using a website address and an Internet browser of the customer/employer computer 103. An example initial webpage for the website is illustrated in FIG. 3A. At the Internet website, the customer/employer may be able to register for an account. For example, as shown in the webpage of FIG. 3B, as part of a registration process, the customer/employer may provide a company name, a name of the representative, a telephone number, a zip code, and an email address, according to an example embodiment of the invention. Also, as part of the registration process, the customer/employer may be assigned a username and/or password for use in accessing or interacting with the website.

ii. Quotes

In block 203 of FIG. 2A, the customer/employer may interact with the Internet website to obtain quotes for one or more insurance/benefits plans or products associated with one or more carriers. The customer/employer may provide a request for quote information at the Internet website. The request for quote information may include certain company information and employee information. The request for quote information may also specify one or more insurance/benefits plans or products for one or more carriers from which the customer/employer desires a quote or rate. In response to the quote request, the website may present quotes or rates for one or more insurance/benefits plans or products.

FIG. 2B describes an example quotes process that may be utilized for block 203 of FIG. 2A, although it will be appreciated that variations are available as well. Referring now to FIG. 2B, block 211 may include the customer inputting or otherwise providing company information at the website, perhaps using a webpage similar to the example shown in FIG. 3C. Example company information may include the following information: company name & address, contact name and contact information (e.g., telephone number, email address), total number of employees, total number of eligible employees, and company establishment date. Other company information may be input or otherwise provided at the website, according to an example embodiment of the invention.

Block 213 may follow block 211 where the customer/employer may input or otherwise provide employee information at the website, perhaps using a webpage similar to the example shown in FIG. 3D. Example employee information may include employee census information comprising employee date of birth, employee gender, dependency information (individual, husband & wife, family, etc.), and zip code. Other example employee information may include salary information (e.g., for life and/or disability products), and Medicare eligibility. In block 215, the service provider 104 may receive the company information and the employee information as part of a request for quote information. Responsive to the quote request, the service provider may determine quotes or rates for the requested insurance/benefits plans or products in accordance with the received company information and employee information.

According to an example embodiment of the invention, the service provider 104 may determine the quotes or rates for one or more insurance/benefits plans or products using table rates or other pricing information along with underwriting guidelines, which may be stored or otherwise accessible from database 182. The table rates or other pricing information and underwriting guidelines may have been previously received by the service provider 104 electronically (e.g., via email, electronic system message, facsimile, data file, etc.), perhaps from respective carrier computer 106 via network 110. Alternatively, the service provider may receive other table rates, pricing information, and/or underwriting guidelines from respective carriers via other communication means, including personal correspondence/postal mail, and the received information may be covered to electronic form (e.g., scanning, optical character recognition (OCR), data entry, etc.) for storage in the database 182. The carriers may utilize combinations of electronic and non-electronic communication means for providing the table rates, pricing information, and/or underwriting guidelines, according to an example embodiment of the invention. The table rates, pricing information, and/or underwriting guidelines, or updates thereof, may be received the service provider 104 periodically (e.g., semi-monthly, monthly, etc.) and subsequently stored in the database 182.

Alternatively, where the current table rates or other pricing information are not available in database 182, the service provider 104 may deliver at least a portion of the received quote request having the customer and employee information to the one or more carrier computers 106 or other computers in order to obtain respective quotes or rates from the carrier computers 106. According to an example embodiment of the invention, the service provider 104 may communicate the quote requests to the carrier computers 106 or other computers via network 110. Responsive to the request, the carrier computers 106 or other computers may provide the requested quotes or rates in real-time or in a short amount of time to the service provider 104 via network 110.

It will be appreciated that quotes or rates, either determined using rate tables or based upon communications with the carrier computer 106, may be based at least in part on a location associated with the customer/employer. Indeed, the quotes or rates for a customer/employer for one or more plans or products may vary depending on a zip code location of the customer/employer.

The quotes or rates for one or more plan or products may be aggregated and presented to the customer/employer for review in block 215. FIG. 3E illustrates an example webpage for presenting one or more health, dental and vision, flexible spending account, and life & disability plans or products offered by one or more carriers, according to an example embodiment of the invention. It will be appreciated that there may be multiple quotes or rates for each product or plan for a respective carrier, perhaps based upon the number of individuals to be enrolled (e.g., individual, husband/wife, family, etc.), according to an example embodiment of the invention. In addition, the quotes or rates may provide for an estimated monthly cost, annual cost, or a variation thereof (e.g., cost for 6 months, etc.). FIG. 3F illustrates an example webpage that may be accessible by the customer/employer at the website to compare benefits or coverage by two or more plans or products.

iii. Purchasing

Returning to block 205 of FIG. 2A, the customer/employer may elect to purchase at least one product or plan presented via the Internet website.

FIG. 2C describes an example process that may be utilized for block 205 of FIG. 2B, although it will be appreciated that variations are available as well. Referring now to FIG. 2C, block 221 may include the customer/employer selecting one or more products or plans for purchase at the website. FIG. 3G illustrates an example webpage that summarizes a customer/employer's selected plans or products for purchase. The example webpage of FIG. 3G also provides a respective quote or rate for each selected plan or product (i.e., health, dental, vision, and basic life insurance), as well as an aggregate total cost (e.g., a monthly grand total cost), according to an example embodiment of the invention. In block 221, the customer/employer may provide a purchase instruction at the website for one or more selected product or plans. The purchase instruction indicating the requested purchase of one or more products or plans may be received by the service provider 104.

Following block 221, processing may proceed to block 222. In block 222, the website may direct the customer/employer to complete one or more carrier applications or other documents. As an example, the customer/employer may electronically compete the one or more carrier applications or other documents (e.g., electronic payment (ACH) agreement, business associated agreement, etc.) via the website. For example, employer group insurance applications/agreements may be presented at the website, and the customer/employer may complete the applications/agreements online and sign or execute the agreements using an electronic signature. If the applications and/or other documents can be completed and/or executed electronically via the website, then manually signed agreements may not necessarily be required, thereby expediting an example procurement process in an example embodiment of the invention.

Block 223 may follow block 222. In block 223, the service provider 104 may receive the completed and/or executed applications or documents. In block 223, the service provider may deliver the appropriate applications and/or documents to the appropriate carriers for approval. In example embodiment of the invention, the completed and/or executed applications and/or documents may be delivered electronically (e.g., via email, electronic system message, a file, etc.) from the service provider 104 to respective carrier computers 106 via network 110. Alternatively, the service provider 104 may also direct a mailing of paper copies of the completed and/or executed applications to the appropriate carrier as well. It will be appreciated that multiple applications or documents corresponding to multiple products or plans that are to be purchased may be delivered to one or more carriers.

In block 224, the service provider 104 may receive one or more responses from the one or more carriers. The response may indicate whether the respective carrier approved the respective application from the customer/employer for a particular product or plan. In an example embodiment of the invention, the service provider 104 may receive the approvals electronically, perhaps from respective carrier computers 106 via network 110. If an application from the customer/employer has been denied by a carrier, then processing may proceed to block 225. In block 225, the service provider 104 may notify a customer/employer of the denial of an application for a particular product or plan. The service provider 104 may then notify the customer/employer of the denial and provide instructions to the customer/employer for correcting any errors/problems or otherwise assist in correcting the errors/problems. The notification may be delivered electronically, perhaps via email, electronic system message, or website presentation, from the service provider 104 to the customer/employer computer 103, according to an example embodiment of the invention. Alternatively, the notification may also be a mailed paper notification (or other personal correspondence) or facsimile notification, according to an example embodiment of the invention.

On the other hand, block 224 may determine that one or more applications for particular products or plans have been approved. In this case, processing may proceed to block 226, where the service provider 104 may notify the customer/employer of the approved applications for one or more products or plans. According to an example embodiment of the invention, the approval notification may be delivered electronically, perhaps via email, electronic system message, or website presentation, from the service provider 104 to the customer/employer computer 103. Alternatively, the notification may also be a mailed paper notification (or other personal correspondence) or facsimile notification, according to an example embodiment of the invention.

Following block 226, processing may proceed to block 227. In block 227, the service provider 104 may direct delivery of enrollment instructions for prospective employees/dependents to the employer/customer. The enrollment instructions may provide instructions indicating how an employer/customer can enroll one or more employees/dependents. In an example embodiment of the invention, the enrollment instructions may be delivered electronically, perhaps via email, electronic system message, or website presentation, from the service provider 104 to the customer/employer computer 103. Alternatively, the enrollment instructions may also be mailed or faxed to the employer/customer, according to an example embodiment of the invention. It will also be appreciated that blocks 226 and 227 may be combined such that the enrollment instructions are delivered in conjunction with the approval notification, according to an example embodiment of the invention.

iv. Enrollment

Returning to FIG. 2A, in block 207, the customer/employer may receive the enrollment instructions. In response to the enrollment instructions, the customer/employer, or one or more individuals (e.g., the employees themselves) associated therewith, may provide the enrollment information to the service provider 104 via the website, according to an example embodiment of the invention. FIG. 3H illustrates an example webpage that a customer/employer or other individual may access in order to provide enrollment information to the service provider 104 via the website. Example enrollment information may include the following:
Name of Employee and any enrolling Dependents (e.g., spouse, children, etc.),
Residential/Mailing Address for Employee
Social Security Number or other Identifier of the Employee and/or enrolling Dependents,
Date of Birth for Employee and any enrolling Dependents, and/or
Identification of which plans or products the Employee and/or Dependents wish to enroll in (e.g., Family for Medical Plan #1, Employee/Spouse for Dental Plan #2, Employee(self) for Vision insurance plan).

In block 235, the enrollment information may be received via the website. The enrollment information may then be validated in block 235 to determine whether there is any information missing from the enrollment information. If no information is missing in block 235, then processing may proceed to block 237.

Block 237 may include providing the received enrollment information to the one or more carriers associated with the products or plans being purchased. In an example embodiment of the invention, the enrollment information may be transmitted from the service provider 104 to the respective carrier computer 106 via network 110. For example, the transmitted enrollment information may be formatted in accordance with a version of the Benefit Enrollment and Maintenance Transaction Set (834) utilized in the context of an Electronic Data Interchange (EDI) environment. However, it will be appreciated that other standards, protocols, or electronic system messages may be utilized for electronic transmitting the enrollment information from the service provider 104 to the respective carrier computer 106 via network 110. Alternatively, the service provider 104 may also deliver enrollment information to one or more carriers via email, website presentation, facsimile, personal correspondence/postal mail, or another communications means.

Block 239 may include the service provider 104 requesting, processing, or directing an initial payment from the customer/employer. Block 239 may include the service provider 104 initiating an electronic payment from an account of the customer/employer in accordance with an electronic payment authorization provided by the customer/employer. Alternatively, block 239 may include the service provider 104 delivering an invoice to the customer/employer, perhaps via email, electronic system message, website presentation, facsimile, or postal mail. The invoice may identify the purchased products or plans, and further request payment of an aggregate payment amount to cover the purchased products or plans. The invoice may also be additionally itemized to indicate costs that are attributed to each enrolled employee.

v. Administration

Returning to FIG. 2A, in block 209, the service provider 104 may provide ongoing insurance/benefits administration and/or billing, according to an example embodiment of the invention. As part of the ongoing administration, a customer/employer may utilize the website to update enrollment information for one or more employees. As an example, updates may include adding/changing/terminating employee(s), adding/terminating dependents, and/or adding/changing/terminating benefit coverage. Indeed, block 209 may be “single entry” at a website, whereby a customer/employer may key, enter, or upload employee enrollment information (e.g., name, address, spouse and dependent names, dates of birth, etc.) “one time” to enroll or change coverage status in multiple carrier plans (e.g., health insurance, dental & vision insurance, life & disability insurance, flexible spending account, etc.). FIGS. 3I-K illustrates example webpages that a customer/employer or other individual may access in order to provide updated enrollment information to the service provider 104 via the website. The updated enrollment information transmitted to a carrier computer 106 via network 110 in accordance with a version of the Benefit Enrollment and Maintenance Transaction Set (834) utilized in the context of an Electronic Data Interchange (EDI) environment.

The updated enrollment information may also be utilized to determine updated quote or rate information. According to an example embodiment of the invention, the service provider 104 may electronically transmit the updated enrollment information to the carrier computers 106 via network 110, and the carrier computers 106 may respond with updated quotes or rates in real-time or a short amount of time. Alternatively, the service provider 104 may utilize the updated enrollment information (e.g., updated census information) and the stored rate tables or pricing information in database 182 to determine updated quotes or rates. The updated quotes or rates may then be presented to the customer/employer via the website.

In addition, block 309 may also include the service provider 104 providing periodic invoices to the customer/employer for the purchased products or plans. In an example embodiment of the invention, the invoices may identify the purchased products or plans, and further request payment of an aggregate payment amount to cover the purchased products or plans. Indeed, a single, electronic premium invoice may be generated for all carriers/products/plans for a particular customer/employer. The invoices may be transmitted electronically (e.g., via email, website presentation, electronic system message, etc.) by the service provider 104 to the respective customer/employer computers 103 via network 110. Alternatively, the invoices may be delivered to the customer/employers via another communications means, including facsimile or personal correspondence/postal mail.

According to an example embodiment of the invention, it will also be appreciated that licensed customer service representatives may be accessible for coverage, enrollment and administrative questions from the customer/employers. Customers/employers may access customer service representatives by telephone or via internet chat. In addition, the website described herein may utilize encryption or other security certificates to ensure that website communications are private and secure.

Based upon the foregoing, embodiments of the invention may be provide for a web-based group insurance procurement and administration system that may combine several business operations into a complete turnkey system. An example embodiment of the invention may also be a substantially electronic system that may eliminate all paper including group carrier agreements, employee enrollment applications and status change forms and premium invoices. Additional functional aspects may also include one or more the following:
Single entry of employee information at a single website location with electronic employee signature,
Paperless, web based system,
Web-based data feed from service provider to carrier computers for rates and enrollment,
Paperless, Online Employer Carrier Agreements and electronic signature,
Online, employer administration for adding new hires, adding or deleting dependents and terminations,
Electronic payments (e.g., ACH Premiums)
Single online premium invoice for multiple coverages,
Zip code rating, and/or
Multi-state application.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system, comprising:
a memory for storing computer-executable instructions;
a processor in communication with the memory, wherein the processor is operable to execute the computer-executable instructions to:
receive a request for quote information from a customer computer via a website;
responsive to the request, provide rates for a plurality of insurance/benefits products associated with one or more carriers via the website, wherein the plurality of insurance/benefits products includes a first insurance/benefits product associated with a first carrier of the one or more carriers;
receive, from the customer computer via the website, a purchase instruction requesting a purchase of at least the first insurance/benefits product;
receive, from the customer computer via the website, a first electronic application, wherein the first electronic application is executed electronically; and
direct a transmission of the first electronic application to the first carrier of the first insurance/benefits product for approval or denial, wherein upon receiving an approval response or a denial response from the first carrier, notifying a customer of the approval response or the denial response for the first insurance/benefits product.

2. The system of claim 1, wherein an approval response is received from the first carrier, and wherein the processor is further configured to execute the computer-executable instructions to:
receive, from the customer computer via the website, enrollment information associated with employees of the customer; and
direct a transmission of the enrollment information to the first carrier.

3. The system of claim 1, wherein the insurance/benefits products include one or more of health insurance, dental & vision insurance, life & disability insurance, flexible spending account benefits, or wellness and occupational health products.

4. The system of claim 1, wherein the customer is notified of the approval response or the denial response via email, electronic system message, website presentation, or personal correspondence.

5. The system of claim 1, wherein the plurality of insurance/benefits products includes a second insurance/benefits product associated with a second carrier of the one or more carriers, wherein the purchase instruction further requests a purchase of the second insurance/benefits product, and wherein the processor is further operable to execute the computer-executable instructions to:
receive, from the customer computer via the website, a second electronic application, where the second electronic application is executed electronically; and
direct a transmission of the second electronic application to the second carrier of the second insurance/benefits product for approval or denial, wherein upon receiving an approval response or a denial response from the first carrier, notifying the customer of the approval response or the denial response for the first insurance/benefits product.

6. The system of claim 5, wherein an approval response is received from the first carrier, wherein an approval response is received from the second carrier, and wherein the processor is further operable to execute the computer-executable instructions to:
direct a transmission of a consolidated invoice to the customer, wherein the consolidated invoice is associated with at least the first insurance/benefits product and the second insurance/benefits product.

7. The system of claim 1, wherein the request for quote information includes location information associated with the customer, wherein the rates for a plurality of insurance/benefits products are determined based at least in part on the location information.

8. The system of claim 7, wherein the location information includes a zip code.

9. The system of claim 1, wherein at least a portion of the provided rates are determined by communicating with one or more carrier computers over a network.

10. The system of claim 9, wherein the received request for quote information includes employer information and employee information.

11. A method, comprising:
receiving a request for quote information from a customer computer via a website;
responsive to the request, providing rates for a plurality of insurance/benefits products associated with one or more carriers via the website, wherein the plurality of insurance/benefits products includes a first insurance/benefits product associated with a first carrier of the one or more carriers;
receiving, from the customer computer via the website, a purchase instruction requesting a purchase of at least the first insurance/benefits product;
receiving, from the customer computer via the website, a first electronic application, wherein the first electronic application is executed electronically; and
directing a transmission of the first electronic application to the first carrier of the first insurance/benefits product for approval or denial, wherein upon receiving an approval response or a denial response from the first carrier, notifying a customer of the approval response or the denial response for the first insurance/benefits product.

12. The method of claim 11, wherein an approval response is received from the first carrier, and further comprising:
receiving, from the customer computer via the website, enrollment information associated with employees of the customer; and
directing a transmission of the enrollment information to the first carrier.

13. The method of claim 11, wherein the insurance/benefits products include one or more of health insurance, dental & vision insurance, life & disability insurance, flexible spending account benefits, or wellness and occupational health products.

14. The method of claim 11, wherein the customer is notified of the approval response or the denial response via email, electronic system message, website presentation, or personal correspondence.

15. The method of claim 11, wherein the plurality of insurance/benefits products includes a second insurance/benefits product associated with a second carrier of the one or more carriers, wherein the purchase instruction further requests a purchase of the second insurance/benefits product, and further comprising:
receiving, from the customer computer via the website, a second electronic application, wherein the second electronic application is executed electronically; and
directing a transmission of the second electronic application to the second carrier of the second insurance/benefits product for approval or denial, wherein upon receiving an approval response or a denial response from the first carrier, notifying the customer of the approval response or the denial response for the first insurance/benefits product.

16. The method of claim 15, wherein an approval response is received from the first carrier, wherein an approval response is received from the second carrier, and further comprising:
directing a transmission of a consolidated invoice to the customer, wherein the consolidated invoice is associated with at least the first insurance/benefits product and the second insurance/benefits product.

17. The method of claim 11, wherein the request for quote information includes location information associated with the customer, wherein the rates for a plurality of insurance/benefits products are determined based at least in part on the location information.

18. The method of claim 17, wherein the location information includes a zip code.

19. The method of claim 11, wherein at least a portion of the provided rates are determined by communicating with one or more carrier computers over a network.

20. The method of claim 19, wherein the received request for quote information includes employer information and employee information.
